(19) United States
(12) Patent Application Publication
(10) Pub. No.: US 2015/0372492 A1
(43) Pub. Date: Dec. 24, 2015

(54) REPOWERING SCR RIGS TO AC TECHNOLOGY

(71) Applicant: NABORS DRILLING USA, Houston, TX (US)

(72) Inventors: Beat KUTTEL, Spring, TX (US); Ted ROYER, Houston, TX (US); Todd FOX, Houston, TX (US)

(21) Appl. No.: 14/765,947

(22) PCT Filed: Feb. 4, 2014
(86) PCT No.: PCT/US2014/014568

§ 371 Date: Aug. 5, 2015

Related U.S. Application Data
(60) Provisional application No. 61/762,209, filed on Feb. 7, 2013.

(51) Int. Cl. H02J 5/00; E21B 21/08; E21B 19/02; H02P 27/06; E21B 3/02

(52) U.S. Cl. CPC H02J 5/00; H02P 27/06; E21B 3/02; E21B 19/02; E21B 21/08

(57) ABSTRACT

A power delivery system that includes at least one generator where the generator is positioned to provide AC power and a rectifier, where the rectifier is electrically coupled to the generator. The rectifier is positioned to convert the AC power to DC power. The power delivery system further includes an SCR, where the SCR is positioned to receive DC power from the rectifier. The SCR is adapted to selectively switch a DC motor from an off to an on position. The power delivery system also includes an inverter. The rectifier is positioned to receive DC power from the rectifier and to supply AC current to an AC motor.

### CROSS-REFERENCE TO RELATED APPLICATIONS

This application is a non-provisional application which claims priority from U.S. provisional application No. 61/762,209, filed Feb. 7, 2013.

### FIELD OF THE DISCLOSURE

The present disclosure is related generally to power delivery systems, and specifically to power control systems for drilling rigs.

### BACKGROUND OF THE DISCLOSURE

Many oil and gas drilling rigs use silicon controlled rectifier (“SCR”) power controllers to convert AC power from near-rig generators to provide DC power to DC equipment on the rig, including, but not limited to mud pumps, top drives, drawworks, and other rig equipment. A SCR is a four-layer solid-state current controlling device generally used in switching applications. In the normal “off” state, the device restricts current to the leakage current. When the gate-to-cathode voltage exceeds a certain threshold, the device turns “on” and conducts current. The device will remain in the “on” state even after gate current is removed so long as current through the device remains above the holding current. Once current falls below the holding current for an appropriate period of time, the device will switch “off.” As they are unidirectional, they are generally only suitable for supplying DC power.

Typically, a plurality of SCRs, combined in a “line-up” which is normally located within a structure, often termed an “SCR house” are positioned to provide switching for the DC equipment. For cost and other reasons, the SCR house is most often very crowded with SCRs and associated equipment, thereby leaving little if any room for additional equipment. As understood in the art, AC motors may be capable of providing higher torque in a more compact design. Additionally, unlike DC motors, AC motors may be able to provide torque at very low speeds or have a substantial amount of torque available at standstill.

### SUMMARY

The present disclosure provides for a power delivery system for a drilling rig. The power delivery system may include at least one generator, the generator positioned to provide AC power; an SCR, the SCR positioned to receive AC power from the generator, the SCR adapted to supply DC current to a DC motor; a rectifier, the rectifier electrically coupled to the generator, the rectifier positioned to convert the AC power to DC power; an inverter, the inverter positioned to receive DC power from the rectifier, the inverter positioned to supply AC current to an AC motor.

The present disclosure also provides for a method for converting an SCR powered drilling rig to VFD power. The method may include setting an SCR to an always on position, the SCR allowing DC power to pass therethrough; electrically coupling an inverter to the DC power output of the SCR; and and coupling an AC motor to the inverter.

The present disclosure also provides for a power delivery system for converting an SCR powered drilling rig to VFD power. The power delivery system may include an inverter, the inverter positioned to receive DC power from an SCR, the SCR configured in an always on position, the inverter positioned to supply AC current to an AC motor.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 depicts a VFD power control system consistent with at least one embodiment of the present disclosure.

FIG. 2 depicts a VFD power control system consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

“Rectifier,” as the term is used herein, is defined as an electrical device that converts alternating current to direct current. The process is known as rectification. “Inverter,” as the term is used herein, is defined as an electrical power converter that changes DC current to alternating current. The inverter performs the opposite function of a rectifier. The electrical inverter is a high-power electronic switch such as a field effect transistor (“FET”).

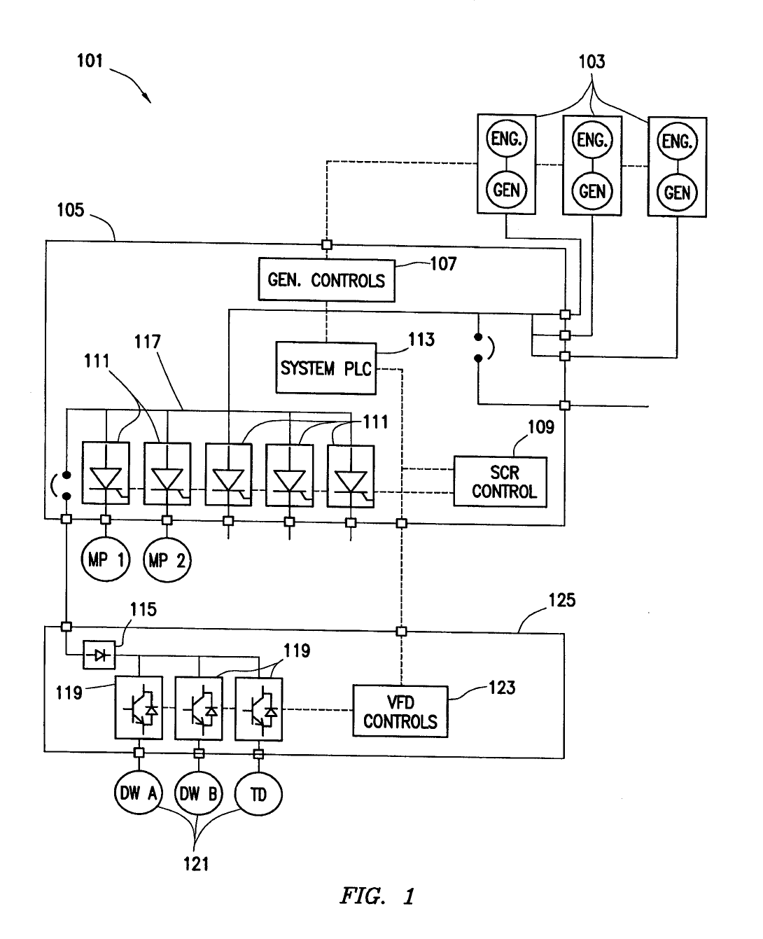

FIG. 1 depicts power control system 101 consistent with embodiments of the present disclosure. Power control system 101 may be powered by one or more generators 103. Generators 103 supply AC current to AC bus 117 and to the rest of power control system 101. In some embodiments, an existing drilling rig may include SCR house 105. As understood in the art, SCR house 105 may be an enclosed self-supporting structure that includes, but is not limited to Generator Controls 107, SCR controllers 109, SCRs 111 Power Distribution and Motor Control Center (MCC) depicted as System PLC 113. Typically, an SCR is used to control DC motors.

In some embodiments, AC bus 117 may provide AC power to existing SCRs 111 to run any DC motors being used. For example, as depicted in FIG. 1, the motors for mud pumps 1 and 2 (MP1, MP2) may be DC motors. Because they are generally used only under constant load, their replacement with AC motors may not provide a great advantage to an operator.

In order to use the AC power supplied by generators 103, one or more rectifier 115 may be positioned to convert the AC power into DC power usable by inverters 119. Inverters 119 may be coupled to one or more AC motors 121, depicted in FIG. 1 as drawworks A (DW A), drawworks B (DW B), and top drive (TD). Inverters 119 may be controlled by VFD drive 123. Inverters 119 may provide variable frequency AC power to AC motors 121. In some embodiments, the power supplied by inverters 119 may range from about 0 to about 200 Hz. In some embodiments, each AC motor 121 may be coupled to a corresponding inverter 119. In some embodiments, AC motor 121 may be a three-phase AC motor, with a corresponding three-phase inverter.

Variable frequency AC power may be most useful in applications were positioning is important, such as in hoisting and torque control applications. Examples of such applications include, but are not limited to, drawworks and top drives. In certain embodiments of the present disclosure, variable frequency AC power may be supplied only to hoisting and torque control applications on the drilling rig. By limiting the number of applications for which variable frequency AC power is used, the number of inventers 119 may be limited, thereby saving the expense of including inverters for applications where position may not be critical, such as for motors for mud pumps.

In some embodiments of the present disclosure, an existing drilling rig may be repowered from SCR to VFD technology without completely dismantling and removing or replacing SCR house 105. As such, the overall cost of building and operating the drilling rig may be reduced. In some embodiments, the present disclosure allows for “Split VFD”, using existing SCR hardware, and adding new VFD equipment to the rig floor. In some embodiments of the present disclosure, the process comprises repowering SCR rigs to AC technology by splitting the inverter and rectifier, utilizing an already installed SCR to form the function of the rectifier, by keeping the SCR switched to the “always on” position.

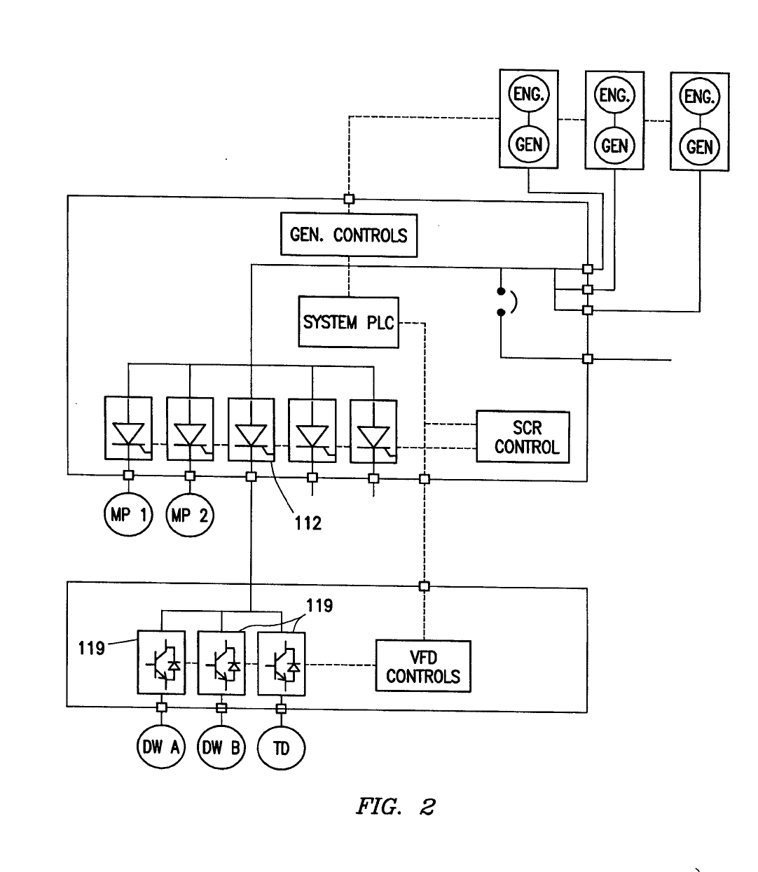

In some embodiments, as depicted in FIG. 2, an existing SCR 112 in SCR house 105 may be utilized to supply power to inverters 119. The existing SCR 112 may be set to “always on”. The DC output of the existing SCR 112 may be supplied to inverters 119, allowing, for example, an existing output of SCR house 105 to be used to supply power to inverters 119.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions and alterations herein without departing from the spirit and scope of the present disclosure.

What is claimed is:

1. A power delivery system for a drilling rig, the power delivery system comprising:
at least one generator, the generator positioned to provide AC power;
an SCR, the SCR positioned to receive AC power from the generator, the SCR adapted to supply DC current to a DC motor;
a rectifier, the rectifier electrically coupled to the generator, the rectifier positioned to convert the AC power to DC power;
an inverter, the inverter positioned to receive DC power from the rectifier, the inverter positioned to supply AC current to an AC motor.

2. The power delivery system of claim 1, wherein the inverter is driven by a VFD, and the AC current supplied by the inverter varies in frequency based on the commands of the VFD.

3. The power delivery system of claim 1, wherein the AC motor is coupled to one of a top drive or drawworks.

4. The power delivery system of claim 1, wherein the DC motor is coupled to a mud pump.

5. The power delivery system of claim 1, wherein the rectifier, inverter, and AC motor are added to an existing power delivery system, the existing power delivery system including the SCR and DC motor.

6. The power delivery system of claim 1, wherein the rectifier is a second SCR, the second SCR configured in an always on configuration.

7. The power delivery system of claim 1, wherein the AC motor is a three phase AC motor, and the inverter supplies three-phase AC power to the AC motor.

8. The power delivery device of claim 1, wherein the AC power supplied to the AC motor has a frequency between 0 and about 200 Hz.

9. A method for converting an SCR powered drilling rig to VFD power comprising:
setting an SCR to an always on position, the SCR allowing DC power to pass therethrough;
electrically coupling an inverter to the DC power output of the SCR; and
coupling an AC motor to the inverter.

10. The method of claim 9, further comprising:
coupling the inverter to a VFD controller, the VFD controller positioned to modulate the output of the inverter into a variable frequency AC current;
supplying the variable frequency AC current to the AC motor.

11. The method of claim 9, further comprising:
supplying DC power from a second SCR to a DC motor.

12. The method of claim 9, wherein the AC motor is coupled to one of a top drive or drawworks.

13. The method of claim 11, wherein the DC motor is coupled to a mud pump.

14. The method of claim 9, wherein the AC motor is a three phase AC motor, and the inverter supplies three-phase AC power to the AC motor.

15. The method of claim 9, wherein the AC power supplied to the AC motor has a frequency between 0 and about 200 Hz.

16. A power delivery system for converting an SCR powered drilling rig to VFD power, the power delivery system comprising:
an inverter, the inverter positioned to receive DC power from an SCR, the SCR configured in an always on position, the inverter positioned to supply AC current to an AC motor.

17. The power delivery system of claim 16, wherein the inverter is controlled by a VFD controller positioned to modulate the output of the inverter into a variable frequency AC current.

18. The power delivery system of claim 16, wherein the AC motor is coupled to one of a top drive or drawworks.

19. The power delivery system of claim 16, wherein a second SCR is positioned to supply DC power to a DC motor.

20. The power delivery system of claim 19, wherein the DC motor is coupled to a mud pump.
